(19) United States
(12) Patent Application Publication
(10) Pub. No.: US 2010/0195337 A1
(43) Pub. Date: Aug. 5, 2010

(54) ELECTROLUMINESCENT ARRANGEMENT ON TEXTILE MATERIALS

(75) Inventors: Michael Heite, Olpe (DE); Thilo-J. Werners, Leverkusen (DE); Joerg Muenz, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/676,238

(22) PCT Filed: Sep. 3, 2008
(86) PCT No.: PCT/EP2008/061603

§ 371 Date: Mar. 3, 2010

(30) Foreign Application Priority Data
Sep. 4, 2007 (DE) 102007000693.6

(51) Int. Cl. H05B 33/02; B60Q 1/00; H01J 9/00; A47C 7/24; F21V 21/08

(52) U.S. Cl. 362/459; 313/506; 445/29; 362/131; 362/103

(57) ABSTRACT

An electroluminescent arrangement is described, which comprises at least one flexible electroluminescent element and at least one flexible textile carrier material.

The present invention relates to an electroluminescent arrangement, processes for its production, and its use as a lighting element.

Electroluminescence (hereinafter also abbreviated to “EL”) is understood to mean the direct excitation of luminescence from luminescent pigments or luminophores by an alternating electric field.

Electroluminescence technology has recently become increasingly important. This technology enables homogeneous luminous surfaces free of dazzle and shadow and of virtually any desired size to be formed. At the same time the power consumption and structural thickness (of the order of magnitude of a millimetre or less) are extremely low. Typical uses include, apart from the background illumination of liquid crystal displays, the back-lighting of transparent films that are provided with lettering and/or image motifs. Thus, transparent electroluminescent arrangements, for example electroluminescent luminous boards based on glass or transparent plastics, which can serve for example as information carriers, advertising panels, or for decorative purposes, are known from the prior art.

A zinc sulfide electroluminescent arrangement based on the use of two electrodes of conducting glass with an electroluminescent phosphor arranged therebetween was already described in 1950 by E. C. Payne in U.S. Pat. No. 2,838,715, and a publication by G. Destriau “The New Phenomenon of Electroluminescence and its Possibilities for the Investigation of Crystal Lattice” in the “Philosophical Magazine” was mentioned by way of reference, in which connection the original discovery of the particular ZnS EL phenomenon in an alternating voltage field was already made by Destriau in 1936.

The luminescent pigments and luminophores that are used in these EL elements are embedded in a transparent, organic or ceramic binder. The starting substances are generally zinc sulfides, which depending on doping or co-doping and preparation procedure generate different, relatively narrow-band emission spectra. The reason for the use of zinc sulfides in the electroluminescent layers is due on the one hand to the relatively large number of zinc sulfide electroluminescent pigments that are available. The centre of gravity of the spectrum at the same time determines the respective colour of the emitted light. The emission colour of an electroluminescent element can be matched by means of a large number of possible measures to the desired colour impression. These measures include the doping and co-doping of the luminescent pigments, the mixing of two or more electroluminescent pigments, the addition of one or more organic and/or inorganic colour-converting and/or colour-filtering pigments, the coating of the electroluminescent pigment with organic and/or inorganic colour-converting and/or colour-filtering substances, the admixture of colorants to the polymer matrix in which the luminescent pigments are dispersed, as well as the incorporation of a colour-converting and/or colour-filtering layer or film in the structure of the electroluminescent element. In general, depending on the employed doping and co-doping of the zinc sulfide pigments a relatively broad-band emission spectrum is produced if a suitably high alternating voltage of typically greater than 50 volts up to more than 200 volts and a frequency of greater than 50 Hz up to a few kHz, normally in the range from 400 Hz to 2 kHz, is applied.

In order that the produced emission can be seen, at least one flat (planar) electrode is preferably designed to be largely transparent.

Depending on the intended use and production technology, glass substrates or polymeric films with an electrically conducting and largely transparent coating can be used for this purpose. In special embodiments an electroluminescent capacitor structure can also be arranged on a substrate in such a way that as front transparent electrode only a thin layer is printed or knife coated, or applied by a roller coating method or a curtain casting method or a spray method. In principle both flat electrodes can also be made largely transparent and in this way a translucent electroluminescent element is formed that exhibits a light emission on both sides.

In the large number of interior lighting units, such as for example of automobiles, that are employed nowadays, filament lamps are still largely used, which are arranged behind a transparent plate of glass or plastics material. A considerable effort is required to install such lighting units, since corresponding installation openings for snap-type fitting, clip-type fitting or screwing in light housings in the vehicle are needed. In principle there is therefore a need for alternative implementations of interior lighting units, such as are exemplified by electroluminescent arrangements.

In EP 1 053 910 A an interior lighting unit for vehicles, preferably automobiles, is described, comprising at least one luminous field that is connected to a voltage source of the vehicle and is formed by at least one film-like electroluminescing panel-shaped radiator, wherein the luminous field is located underneath an inner lining of the vehicle interior and the inner lining itself consists of transparent textile material or transparent foamed material.

In U.S. Pat. No. 6,464,381 an interior assembly having a lighting effect for a vehicle is described, wherein an electroluminescent panel is arranged between a substrate and a fabric and the electroluminescence emission takes place through the fabric. In addition the arrangement of a foamed material between the fabric and the substrate is described and a layer of foam with fabric arranged thereabove is recommended, the electroluminescent panel being arranged between the fabric and the foamed material. In U.S. Pat. No. 5,013,967 a panel-shaped radiator is described, to which is connected a plug. The panel-shaped radiator forms together with the plug an electroluminescent lamp, which is plugged in the manner of a filament lamp into a socket in the vehicle. In order that the panel-shaped radiator is not damaged due to repeated insertion and removal of the electroluminescent lamp, the radiator is designed so that it has a high mechanical strength.

In EP 0 334 799 A an interior lighting unit is described, in which an electroluminescent film is used in a housing. The housing is mounted from outside on an interior lining of the vehicle. The housing is provided on the underneath with insertion studs or pins, which penetrate the inner lining and engage in corresponding openings in the body of the vehicle.

In EP 1 053 910 A an interior lighting unit for vehicles is described, which includes at least one luminous field that is connected to a voltage supply of the vehicle and is formed by at least one film-like panel-shaped radiator that radiates light. In the conducting path from the voltage source to the luminous field is provided at least one DC/AC transformer, to which a converter is connected downstream. The luminous field is located underneath the inner lining of the vehicle interior.

In the prior art it is not mentioned that a corresponding electroluminescent arrangement can be used in combination with a flexible textile fabric as carrier material. The applications described in the prior art do not generally require the employed electroluminescent element to be designed so as to be flexible, since the elements are arranged in the interior on a non-flexible part of the vehicle.

The electroluminescent arrangements known from the prior art are therefore not suitable for flexible applications, i.e. for applications in which folding, bending and/or turning up of the electroluminescent arrangement is necessary.

The object of the invention is to provide an electroluminescent arrangement that is designed so as to be flexible.

A further object of the present invention is to provide an electroluminescent arrangement that can be used in the region of the roof of a vehicle or for other objects in the interior of a vehicle.

Moreover, the electroluminescent arrangement should preferably occupy as small a space as possible and require only a small installation effort, and provide a uniform distribution of the luminous radiation also in the case of relatively long lighting strips.

This object is achieved by an electroluminescent arrangement.

The electroluminescent arrangement according to the invention is characterised in that the electroluminescent arrangement comprises at least one flexible electroluminescent element and at least one flexible textile canner material.

According to the invention it is therefore proposed that the electroluminescent element be designed so as to be flexible, in order that it can execute the movements and working of the similarly flexible textile carrier material without restricting its functional capability.

The electroluminescent arrangement according to the invention comprises at least one flexible textile carrier material. This flexible textile carrier material is arranged on at least one side of the flexible electroluminescent element provided according to the invention. Furthermore the electroluminescent arrangement according to the invention may for example also comprise two flexible textile carrier materials, which are provided on both sides of the electroluminescent element. In this connection one of the two flexible textile carrier materials can be part of a larger textile arrangement, such as for example part of a roof of a vehicle. The electroluminescent element arranged thereon is then likewise covered on the other side by a textile carrier material, which extends for example in the direction of the observer.

In addition systems of several electroluminescent arrangements according to the invention arrayed next to one another are also possible.

The individual constituents of the electroluminescent arrangement according to the invention are described in more detail hereinafter.

Electroluminescent Element

The electroluminescent arrangement according to the invention includes at least one electroluminescent element.

The electroluminescent element can in general include the following functional layers, though in some embodiments individual functional layers can also be dispensed with:
a) a transparent or non-transparent rear electrode as component BE;
b) a first insulating layer as component BD;
c) a layer containing at least one luminous substance that can be excited by an electrical field, as component BC;
d) optionally a further insulating layer as component BB; and
e) at least one partially transparent cover electrode (=front electrode) as component BA.

The electroluminescent arrangement according to the invention is thus based in general on an inorganic thick-film AC system, which can be produced for example using conventional flat bed and/or cylinder screen printing machines. The production of the electroluminescent arrangement according to the invention is thus possible in a simple manner using conventional and available equipment.

The individual constituents of the electroluminescent system (electroluminescent arrangement) are described in more detail hereinafter:

Components BA and BE−cover electrode and rear electrode (1)

Suitable electrically conducting materials for the electrodes are known to the person skilled in the art. In principle several types of electrodes are available for the production of thick-film EL elements exhibiting alternating voltage excitation. These include on the one hand indium-tin oxide electrodes (indium-tin oxides, ITO) applied by sputtering or vapour deposition to plastics films. They are extremely thin (a few 100 Å) and have the advantage of a high transparency combined with a relatively low sheet resistance (ca. 60 to 600Ω).

Furthermore printing pastes with ITO or ATO (indium-tin oxides, antimony-tin oxide) or intrinsically conducting transparent polymer pastes can be used, from which flat electrodes can be produced by means of screen printing. In a thickness of ca. 0.5 to 20 μm such electrodes have only a relatively small transparency with a high sheet resistance (up to 50 kΩ). They can be applied largely in any desired structural shape, and indeed also on structured surfaces. In addition they have a relatively good laminability. Also, non-ITO screen printing layers (wherein the term “non-ITO” includes all screen printing layers that are not based on indium-tin oxide (ITO)), in other words intrinsically conducting polymeric layers with normally nanoscale electrically conducting pigments, for example the ATO printing pastes with the designations 7162E or 7164 from DuPont, the intrinsically conducting polymer systems, such as the Orgacon® system from Agfa, the Baytron® poly-(3,4-ethylenedioxythiophene) system from H.C. Starck GmbH, the Ormecon system termed organic metal (PEDT-conductive polymer polyethylene-dioxythiophene), conducting coating or printing paste systems from Panipol OY and optionally with highly flexible binders, for example based on PU (polyurethanes), PMMA (polymethyl methacrylate), PVA (polyvinyl alcohol), or modified polyaniline, can be used. Preferably the Baytron® poly-(3,4-ethylenedioxythiophene) system from H.C. Starck GmbH is used as the material of the at least partially transparent electrode of the electroluminescent element. Examples of electrically conducting polymer films are polyanilines, polythiophenes, polyacetylenes, polypyrroles (Handbook of Conducting Polymers, 1986), with and without a metal oxide filling.

In addition tin oxide pastes can also be used as corresponding electrode material.

It is also possible that the electrically conducting coating is a thin and largely transparent metallic or metal oxide layer produced by vacuum technology or pyrolytically, which preferably has a sheet resistance of 5 mΩ/square to 3,000 mΩ/square, particularly preferably a sheet resistance of 0.1 to 1,000 mΩ/square, most particularly preferably 5 to 30 mΩ/square, and in a further preferred embodiment has a daylight transmissibility of at least greater than 60% (>60 to 100%) and in particular greater than 76% (>76 to 100%).

In the context of the present invention it is however possible to use intrinsically conducting polymers, especially of the type described above, as electrode material. The sheet resistance of corresponding electrodes formed from intrinsically conducting polymers should in general be 100 to 2000Ω/square, particularly preferably 200 to 1500Ω/square, especially 200 to 1000Ω/square, and specifically 300 to 600Ω/square.

The electrode materials can for example be applied by screen printing, knife coating, spraying, brushing, by applying a vacuum or pyrolytically to corresponding carrier materials (substrates), this preferably then being followed by drying at relatively low temperatures of for example 80° to 120° C.

The rear electrode (component BE) is—as in the case of the at least partially transparent cover electrode (component BA)—a flat electrode, which however need not be transparent or at least partially transparent. This electrode is in general constructed of inorganically or organically based electrically conducting materials, for example of metals such as silver. Suitable electrodes are furthermore in particular polymeric electrically conducting coatings. In this connection the coatings already mentioned above in connection with the at least partially transparent cover electrode can be used. In addition, those polymeric electrically conducting coatings known to the person skilled in the art and which are not at least partially transparent can also be used.

Suitable materials of the rear electrode are thus preferably selected from the group consisting of metals such as silver, carbon, ITO screen printing layers, ATO screen printing layers, non-ITO screen printing layers, in other words intrinsically conducting polymeric systems containing normally nanoscale electrically conducting pigments, for example ATO screen printing pastes with the reference identification 7162E or 7164 from DuPont, intrinsically conducting polymer systems such as the Orgacon® System from Agfa, the Baytron® poly-(3,4-ethylenedioxythiophene) system from H.C. Starck GmbH, the system from Ormecon termed organic metal (PEDT conductive polymer polyethylene-dioxythiophene), electrically conducting coating and printing ink systems from Panipol Oy and optionally with highly flexible binders, for example based on PU (polyurethanes), PMMA (polymethyl methacrylate), PVA (polyvinyl alcohol) or modified polyaniline, wherein metals such as silver or carbon can be added to and/or incorporated as a layer in these materials in order to improve their electrical conductivity.

Moreover, in a first embodiment it is possible for the cover electrode (component BA) to include particles with nanostructures.

It is also possible, in a second embodiment, for the rear electrode (component BE) to include particles with nanostructures.

In a third configuration both the cover electrode BA and the rear electrode BE contain particles with nanostructures.

In the scope of the present invention the expression “particles with nanostructures” is understood to denote nano-scale material structures that are selected from the group consisting of single-wall carbon nanotubes (SWCNTs), multi-wall carbon nanotubes (MWCNTs), nanohorns, nanodisks, nanocones (i.e. structures with conically shaped jackets), metallic nanowires and combinations of the aforementioned particles. Corresponding particles with nanostructures based on carbon can for example consist of carbon nanotubes (single-wall and multi-wall), carbon nanofibres (herringbone, platelet-type, screw-type) and the like. Carbon nanotubes are internationally also termed carbon nanotubes (single-walled and multi-walled) and carbon nanofibres are also termed carbon nanofibres (herringbone, platelet or screw-type).

The production of these single-walled carbon nanotubes is known to the person skilled in the art and reference can be made to corresponding processes in the prior art. These include for example catalytic chemical gaseous phase deposition CCVD:

These processes often produce fractions that differ as regards their diameter, length, chirality and electronic properties. They occur in the form of bundles and are often mixed with a proportion of amorphous carbon. The SWCNTs are separated out from these fractions.

The separation processes known hitherto for SWCNTs are based on electron transfer effects on metallic SWCNTs treated with diazonium salts, on dielectrophoresis, on a special chemical affinity of semiconducting carbon nanotubes for octadecylamines and on carbon nanotubes that are covered with single-strand DNA. The selectivity of these methods can be further improved by intensive centrifugation of pretreated dispersions and the use of ion exchange chromatography. In the context of the present invention preferably fraction-pure single-walled carbon nanotubes are used, i.e. fractions of single-walled carbon nanotubes that differ in terms of a parameter selected from the group consisting of diameter, length, chirality and electronic properties, by at most 50%, particularly preferably by at most 40%, especially by at most 30%, specifically by at most 20% and most specifically by at most 10%.

With regard to metallic nanowires, reference is made to WO 2007/022226 A2, the disclosure of which regarding the nanowires disclosed therein is incorporated by way of reference in the present invention. The electrically highly conducting and largely transparent silver nanowires described in WO 2007/022226 A2 are particularly suitable for the present invention.

The production of the other particles with nanostructures is known to the person skilled in the art and is described in the corresponding documents of the prior art.

With regard to the flexibility of the electroluminescent element according to the invention that is preferably to be achieved for the present invention, it is particularly preferred if the partially transparent electrically conducting flat cover electrode and/or the rear electrode is formed based on an intrinsically conducting polymer, for example Baytron® P from H. C. Starck. In this connection the electrical conductivity and the workability can be improved by suitable additives, such as nanoscale particles based on SWCNTs, silver nanowires, nanocones or nanotubes, wherein the transparency is not substantially influenced. Normally busbar systems are arranged specifically in the contact region of the two flat electrodes, and in this way the electrical contacts can be implemented with a low transition resistance by means of crimping, piercing, clamping or electrically conducting adhesives.

Component BB and BD—insulating layers (dielectric layers) (2)

The electroluminescent element according to the invention comprises at least one dielectric layer (insulating layer, component BB), which is generally provided between the rear electrode (component BE) and the electroluminescent layer (component BC). Moreover several, for example two or three, insulating layers can also be employed at this site. The electroluminescent arrangement according to the invention can in one configuration thus also comprise at least two dielectric layers, which are then arranged next to one another and together improve the insulating effect or which are interrupted (separated) by a floating electrode layer. The use of a second dielectric layer can depend on the quality and pinhole freedom of the first dielectric layer.

In addition the electroluminescent element used according to the invention comprises in a preferred embodiment also a dielectric layer (insulating layer, component BD) between the electroluminescent layer (component BC) and the cover electrode (component BA).

Suitable dielectric layers are known to the person skilled in the art. Suitable layers often include highly dielectrically acting powders, such as for example barium titanate, which are preferably dispersed in fluorene-containing plastics or in cyano-based resins. Examples of particularly suitable particles are barium titanate particles in the range of preferably 1.0 to 2.0 μm. With a high degree of filling these can produce a relative dielectric constant of up to 100.

The dielectric layer has a thickness of generally 1 to 50 μm, preferably 2 to 40 μm, particularly preferably 5 to 25 μm, especially 8 to 15 μm.

In the context of the present invention this layer is also preferably designed so as to be flexible and foldable. This is achieved for example by a polyurethane-based PU screen printing ink and more particularly by a two-component PU screen printing ink, wherein in order to increase the relative dielectric constant barium titanate (BaTiO₃) pigments of the type mentioned above can be added. In this way a relative dielectric constant of 30 to 200 can be achieved. Since such BaTiO₃ admixtures produce an opaquely whitish layer, this layer can also be used to reflect the electroluminescence emission. If in addition to the upwardly directed electroluminescence emission a downwardly directed electroluminescence emission is also necessary, then no BaTiO₃ should be added. The dielectric layer can also be implemented twice or multiply, since especially in screen printing the inclusion of small air bubbles (microbubbles) cannot be avoided and this problem can be solved with a double screen printing.

Component BC−electroluminescent layer (3)

The electroluminescent element used according to the invention comprises at least one electroluminescent layer as layer BC. The layer BC can also be formed from several layers having an electroluminescent effect.

The at least one electroluminescent layer BC is generally arranged between the cover electrode (component BA) and optionally a dielectric layer (component BD) and the dielectric layer (component BB). In this connection the electroluminescent layer can be arranged immediately adjacent to the dielectric layer B or optionally one or more further layers can be arranged between the dielectric layer BB and the electroluminescent layer BC. Preferably the electroluminescent layer BC is arranged immediately adjacent to the dielectric layer BB.

The at least one electroluminescent layer can be arranged on the whole internal surface of the cover electrode (component BA) or insulating layer (component BD), or on one or more partial areas of the cover electrode. In the case where the electroluminescent layer is not closed (sealed), but is arranged on a plurality of partial surfaces, for example of the cover electrode, the partial surfaces generally have a mutual interspacing of 0.5 to 10.0 mm, preferably 1 to 5 mm.

Moreover, in the electroluminescent arrangement according to the invention it is possible for the electroluminescent layer to consist of two or more electroluminescent layer elements arranged next to one another and having different electroluminescent phosphor pigments, so that different colours can be generated in the scope of the electroluminescent arrangement.

The electroluminescent layer is in general composed of a binder matrix with electroluminescent pigments homogeneously dispersed therein. The binder matrix is generally chosen so as to produce a good adhesive bonding to the cover electrode layer (component BA) and to the dielectric layer (component BD) and the dielectric layer (component BB). In a preferred implementation systems based on PVB or PU are in this connection used for the binder system. In addition to the electroluminescent pigments optionally further additives may also be present in the binder matrix, such as colour-converting organic and/or inorganic systems, colorant additives for a daytime and nighttime light effect and/or reflecting and/or light-absorbing effect pigments such as aluminium flakes, glass flakes or mica platelets. In general the proportion of electroluminescent pigments in the total mass of the electroluminescent layer (degree of filling) is 20 to 75 wt. %, preferably 50 to 70 wt. %.

The electroluminescent pigments used in the electroluminescent layer generally have a thickness of 1 to 50 μm, preferably 5 to 25 μm.

Thick-film AC-EL systems have been well known since Destriau in 1947, and are applied to ITO-PET films generally by means of screen printing. Since zinc sulfide electroluminophores experience a very high degradation in operation, especially at elevated temperatures and in a water vapour atmosphere, nowadays in general microencapsulated electroluminescent phosphors (pigments) are used for long-life thick-film AC-EL lamp structures. It is however also possible to use non-microencapsulated pigments in the electroluminescent element employed according to the invention, as is discussed further hereinafter.

Suitable electroluminescent screen printing pastes are in general formulated based on inorganic substances. Suitable substances are for example highly pure ZnS, CdS, ZnₓCd₁₋ₓS compounds of groups JIB and IV of the Periodic System of the Elements, ZnS being particularly preferably used. The aforementioned substances can be doped or activated and optionally also co-activated. Copper and/or manganese for example are used for the doping. The co-activation is carried out for example with chlorine, bromine, iodine and aluminium. The content of alkali metals and rare earth metals in the aforementioned substances is generally very low, if these are present at all. Most particularly preferably ZnS is used, which is preferably doped or activated with copper and/or manganese and is preferably co-activated with chlorine, bromine, iodine and/or aluminium.

Normal electroluminescence emission colours are yellow, green, green-blue, blue-green and white, the emission colours white or red being able to be obtained by mixtures of suitable electroluminescent phosphors (pigments) or by colour conversion. The colour conversion can generally be implemented in the form of a converting layer and/or by admixture of appropriate dyes and pigments in the polymeric binder of the screen printing inks or in the polymeric matrix in which the electroluminescent pigments are incorporated.

If the electroluminescent arrangement according to the invention is used in an interior of a vehicle, for example in a folding top of a convertible, it is preferred if the electroluminescent element emits the colour white.

The screen printing matrix used for the production of the electroluminescent layer is generally provided with glazing, colour-filtering or colour-converting dyes and/or pigments. The emission colour white or a daytime/nighttime light effect can be generated in this way.

In a further embodiment pigments are used in the electroluminescent layer that have an emission in the blue wavelength range from 420 to 480 nm and are optionally provided with a colour-converting microencapsulation. The colour white can likewise be emitted in this way.

In addition the AC-P-EL screen printing matrix preferably contains wavelength-converting inorganic fine particles based on europium(II)-activated alkaline earth orthosilicate phosphors such as (Ba, Sr, Ca)₂SiO₄:Eu²⁺ or YAG phosphors such as Y₃Al₅O₁₂:Ce³⁺ or Tb₃Al₅O₁₂:Ce³⁺, Sr₂GaS₄:Eu²⁺, SrS:Eu²⁺ (Y,Lu,Gd,Tb)₃(Al,Sc,Ga)₅O₁₂:Ce³⁺ or (Zn,Ca,Sr)(S,Se):Eu²⁺. A white emission can likewise also be achieved in this way.

Corresponding to the prior art the aforementioned electroluminescent phosphor pigments can be microencapsulated. Due to the inorganic microencapsulation techniques good half-life times can be achieved. The EL screen printing system Luxprint® for EL from E.I. du Pont de Nemours and Companies may be mentioned here by way of example. Organic microencapsulation techniques and film-wrap laminates based on the various thermoplastic films are in principle also suitable.

Suitable zinc sulfide microencapsulated electroluminescent phosphor (pigments) are available from Osram Sylvania, Inc. Towanda under the trade names GlacierGLO™ Standard, High Brite and Long Life, and from the Durel Division of the Rogers Corporation under the trade names 1PHS001® High-Efficiency Green Encapsulated EL Phosphor, 1PHS002® High-Efficiency Blue-Green Encapsulated EL Phosphor, 1PHS003® Long-Life Blue Encapsulated EL Phosphor, 1PHS004® Long-Life Orange Encapsulated EL Phosphor.

The mean particle diameters of the microencapsulated pigments used in the electroluminescent layer are in general 15 to 60 μm, preferably 20 to 35 μm.

Non-microencapsulated fine grain electroluminescent pigments, preferably with a high service life, can as already mentioned also be used in the electroluminescent layer of the electroluminescent element according to the invention. Suitable non-microencapsulated fine grain zinc sulfide electroluminescent phosphors are disclosed for example in U.S. Pat. No. 6,248,261 and in WO 01/34723, the relevant disclosure of which is incorporated in the present invention. These preferably have a cubic crystal lattice structure. The non-microencapsulated pigments preferably have mean particle diameters of 1 to 30 um, particularly preferably 2 to 15 μm, most particularly preferably 5 to 10 μm.

Specifically, non-microencapsulated electroluminescent pigments with smaller pigment dimensions down to below 10 μm can be used.

Thus, unencapsulated pigments can also be admixed with the starting materials used according to the present application for the electroluminescent layer, such as for example the screen printing inks, preferably having regard to the special hygroscopic properties of the pigments, preferably the ZnS pigments. In this connection in general binders are used that on the one hand have a good adhesion to so-called ITO layers (indium-tin oxide layers) or to intrinsically conducting polymeric transparent layers, and that on the other hand have a good insulating effect, strengthen the dielectric and thereby effect an improvement of the breakdown strength at high electric field strengths, and in addition in the cured state exhibit a good water vapour barrier effect and additionally protect the phosphor pigments and prolong the service life.

The half-life times of the suitable pigments in the electroluminescent layer, i.e. the time during which the initial brightness of the electroluminescent element according to the invention has fallen by half, are in general at 100 volts or 80 volts and 400 Hz, 400 hours up to 5,000 hours.

The brightness values (electroluminescence emission) are in general 1 to 200 cd/m², preferably 1 to 100 cd/m², particularly preferably 1 to 50 cd/m².

Pigments with longer or shorter half-life times and higher or lower brightness values can however also be used in the electroluminescent layer of the electroluminescent element according to the invention.

In a further embodiment of the present invention the pigments present in the electroluminescent layer have such a small mean particle diameter, or such a low degree of filling in the electroluminescent layer, or the individual electroluminescent layers are configured geometrically so small, or the interspacing of the individual electroluminescent layers is chosen so large, that the electroluminescent element in the case of non-electrically activated luminous structures is configured to be at least partially transparent or to ensure transmissibility. Suitable pigment particle diameters, degrees of filling, dimensions of the luminous elements and interspacings of the luminous elements have been mentioned hereinbefore.

In a further, particularly preferred embodiment the electroluminescent layer in the electroluminescent arrangement is based on an electroluminescent phosphor emitting the colour green and on colour conversion pigments that are homogeneously dispersed in the electroluminescent layer. Suitable colour conversion pigments for this purpose are for example “EL Color Converting Pigments FA-000 Series” from the Sinloihi Co., Ltd. Japan. It is also possible to admix a colour-converting substance such as rhodamine, so that a white emission is obtained. The electroluminescence emission in the region of the colour white is particularly preferred if the electroluminescent arrangement is used in an interior of vehicles.

By using at least two electroluminescent layers it is moreover possible to produce a luminous field that differs locally and in wavelength by choosing at least two adjacently arranged electroluminescent layers containing different electroluminescent phosphor pigments.

The electroluminescent arrangement according to the invention is operated by an electroluminescence voltage supply with an alternating voltage frequency in the range from 200 Hz to above 1,000 Hz.

As already mentioned, it is advantageous for the electroluminescent arrangement according to the invention if the electroluminescent arrangement is designed so as to be flexible. The electroluminescent layer is therefore preferably produced by screen printing techniques, since a good flexibility and foldability is thereby ensured. In this connection a polymeric elastic binder matrix, preferably polyurethane-based and most preferably in a two-component formulation, is used. The zinc sulphide electroluminophore pigments are then dispersed in this binder polymer.

The electroluminescent system provided according to the invention and based on zinc sulfide thick-film alternating current electroluminescence is thus an electroluminescent system that is particularly suitable for the required flexibilty and workability.

A particularly preferred configuration of the electroluminescent element provided according to the invention is now described hereinafter:

In a first particularly preferred embodiment of the present invention the electroluminescent element consists of the following layers (normal structure):
a) an at least partially transparent substrate, component A,
b) at least one electroluminescent arrangement, component B, applied to the substrate and containing the following components:
   ba) an at least partially transparent electrode, component BA, as front electrode,
   bb) optionally an insulating layer, component BB,
   bc) a layer containing at least one luminous pigment (electroluminophore) excitable by an electrical field, termed an electroluminescent layer or pigment layer, component BC,
   bd) optionally an insulating layer, component BD,
   be) a rear electrode, component BE, which can be at least partially transparent,
   bf) a conducting track or a plurality of conducting tracks, component BF, for the electrical contacting of both component BA as well as component BE, wherein the conducting track or the conducting tracks can be applied before, after or between the electrodes BA and BE, the conducting track or the conducting tracks preferably being applied in one work step. The conducting track or conducting tracks can be applied in the form of a silver bus, preferably produced from a silver paste,
   a graphite layer can possibly also be applied before the application of the silver bus
c) a protective layer, component CA, or a film, component CB.

The insulating layers BB and BD can be non-transparent, opaque or transparent, in which connection at least one of the layers must be at least partially transparent if two insulating layers are present.

Also, one or more at least partially transparent graphically configured layers can be arranged externally on the substrate A and/or between the substrate A and the electroluminescent arrangement.

Apart from the aforementioned layers (components A, B and C) the electroluminescent element according to the invention (conventional structure) can comprise one or more reflecting layers. The reflecting layer or layers can in particular be arranged as follows:
externally on the component A,
between the component A and component BA,
between the component BA and component BB, or BC if there is no component BB,
between the component BD and component BE,
between the component BE and component BF,
between the component BF and component CA or CB,
externally on the component CA or CB.

Preferably the reflecting layer, where present, is arranged between the component BC and BD, or BE if there is no component BD.

The reflecting layer preferably includes glass spheres, in particular hollow glass spheres. The diameter of the glass spheres can vary within wide ranges. For example, they can have a size d₅₀ of in general 5 μm to 3 mm, preferably 10 to 200 μm, particularly preferably 20 to 100 μm. The hollow glass spheres are preferably embedded in a binder.

In an alternative embodiment of the present invention the electroluminescent element consists of the following layers (reverse layer structure):
a) an at least partially transparent substrate, component A,
b) at least one electroluminescent arrangement, component B, applied to the substrate and containing the following components
be) a rear electrode, component BE, that can be at least partially transparent,
bb) optionally an insulating layer, component BB,
bc) a layer containing at least one luminous pigment (electroluminophore) that can be excited by an electrical field, called the electroluminescent layer or pigment layer, component BC,
bd) optionally an insulating layer, component BD,
ba) an at least partially transparent electrode, component BA, as front electrode,
bf) a conducting track or plurality of conducting tracks, component BF, for the electrical contacting of component BA as well as of component BE, wherein the conducting track or conducting tracks can be applied before, after or between the electrodes BA and BE, wherein preferably the conducting track or conducting tracks are applied in one work step. The conducting track or conducting tracks can be applied in the form of a silver bus, preferably produced from a silver paste. A graphite layer can possibly also be applied before the application of the silver bus,
c) an at least partially transparent protective layer, component CA and/or a film, component CB.

Also, one or more at least partially transparent graphically configured layers can be arranged on the transparent protective layer C and/or between the transparent protective layer C and the electroluminescent arrangement. In particular, the graphically configured layers can take over the function of the protective layer.

In a particular embodiment of the reverse layer structure the structures B,C mentioned above can be applied to the front side of the substrate, component A, or also to the rear side, or also to both sides of the substrate (double-sided construction). The layers BA to BF can thus be identical on both sides, though they may also differ in one or more layers, so that for example the electroluminescent layer radiates equally on both sides or the electroluminescent element on each side radiates a different colour and/or has a different brightness and/or or a different graphical cofiguration

In addition to the aforementioned layers (components A, B and C) the electroluminescent element according to the invention with a reverse layer structure can include one or more reflecting layers. The reflecting layer or layers can in particular be arranged as follows:
externally on component A,
between component A and component BE,
between component BE and component BB,
between component BB and component BC,
between component BC and component BD,
between component BD and component BA,
between component BA and component BF,
between component BF and component CA or CB,
on component CA or CB.

Preferably the reflecting layer, where present, is arranged between component BC and component BB, or BE if component BB is not present.

For the person skilled in the art it is obvious that the particular embodiments and features mentioned for the conventional structure apply as appropriate, unless otherwise stated, to the reverse layer structure and to the double-sided structure.

The one or more insulating layer(s) BB and/or BD in both the conventional structure as well as in the reverse structure can in particular be omitted if the component BC has a layer thickness that prevents a short circuit between the two electrodes, i.e. components BA and BE.

The features of the individual components of the EL element are described hereinafter:

Electrodes

The EL element according to the invention comprises a first, at least partially transparent, front electrode (=cover electrode) BA and a second electrode, the rear electrode BE.

The expression “at least partially transparent” is understood in the context of the present invention to denote an electrode that is constructed of a material that has a transmission of in general more than 60%, preferably more than 70%, particularly preferably more than 80% and especially more than 90%.

The rear electrode BE need not necessarily be transparent.

Suitable electrically conducting materials for the electrodes are known to the person skilled in the art. In principle several types of electrodes are available for the production of thick-film EL elements exhibiting alternating voltage excitation. These include on the one hand indium-tin oxide electrodes (indium-tin oxides, ITO) applied by sputtering or vapour deposition to plastics films. They are extremely thin (a few 100 Å) and have the advantage of a high transparency combined with a relatively low sheet resistance (ca. 60 to 600Ω).

According to the invention, 10 to 90 wt. %, preferably 20 to 80 wt. %, particularly preferably 30 to 65 wt. %, in each case referred to the total weight of the printing paste, of Clevios P, Clevios PH, Clevios P AG, Clevios P HCV4, Clevios P HS, Clevios PH 500, Clevios PH 510 or arbitrary mixtures thereof, are preferably used for the formulation of a printing paste for the production of the at least partially transparent electrode BA. Dimethyl sulfoxide (DMSO), N,N-dimethylformamide, N,N-dimethylacetamide, ethylene glycol, glycerol, sorbitol, methanol, ethanol, isopropanol, n-propanol, acetone, methyl ethyl ketone, dimethylaminoethanol, water or mixtures of two, three or more of the aforementioned compounds can be used as solvent. The amount of solvent can vary in wide ranges in the printing paste. For example, one formulation according to the invention of a paste can contain 55 to 60 wt. % of solvent, whereas in another formulation according to the invention about 35 to 45 wt. % of a solvent mixture of two or more substances can be used. Furthermore Silquest A187, Neo Rez R986, Dynol 604 and/or mixtures of two or more of these substances can be included as surfactant additive and bonding activator.

The amount of these substances is 0.1 to 5.0 wt. %, preferably 0.3 to 2.5 wt. %, referred to the total weight of the printing paste.

As binder(s), the formulation can contain for example Bayderm Finish 85 UD, Bayhydrol PR340/1, Bayhydrol PR135 or arbitrary mixtures thereof, preferably in amounts of about 0.5 to 10 wt. %, preferably 3 to 5 wt. %. The polyurethane dispersions used according to the invention, which after the drying of the layer form the binder for the conducting layer, are preferably aqueous polyurethane dispersions.

According to the invention, particularly preferred formulations of printing pastes for the production of the partially transparent electrode BA contain:

| Substance | Content/wt. % | Content/wt. % | Content/wt. % | Content/wt. % |
|---|---|---|---|---|
| Clevios P HS (H. C. Starck) | 33 | 48 | 40 | 42.2 |
| Silquest A187 (OSi | 0.4 | 0.5 | 1.2 | 1.0 |
| Specialties) | | | | |
| N-methyl-pyrrolidone | 23.7 | 14.4 | 10.3 | 13.3 |
| Diethylene glycol | 26.3 | 20.7 | 30.0 | 25.4 |
| Proglyde/DMM | 12.6 | 12.4 | 14.5 | 13.6 |
| Bayderm Finish 85 UD | 4.0 | 4.0 | 4.0 | 4.5 |
| (Lanxess) | | | | |

| Substance | Content/wt. % | Content/wt. % |
|---|---|---|
| Clevios P HS (H. C. | 33 | 40 |
| Starck) | | |
| Silquest A187 (OSi | 0.4 | 1.2 |
| Specialties) | | |
| N-methyl-pyrrolidone | 23.7 | 10.3 |
| Diethylene glycol | 26.3 | 30.0 |
| Proglyde/DMM | 12.6 | 14.5 |
| Bayhydrol P340/1 | 4.0 | 4.0 |

By way of departure from the formulations mentioned above for the partially transparent electrode BA, the following ready-for-use, commercially obtainable printing pastes mentioned here by way of example can also be used according to the invention as finished formulations: the Orgacon EL-P1000, EL-P3000, EL-P5000 or EL-P6000 range from Agfa, preferably the EL-P3000 and EL-P6000 range (in particular for formable uses).

These electrode materials can be applied for example by means of screen printing, knife coating, sputtering, spraying and/or brushing on corresponding carrier materials (substrates), which are then preferably dried at low temperatures of for example 80° to 120° C.

In a preferred alternative embodiment the application of the electrically conducting coating is carried out in vacuo or pyrolytically.

Particularly preferably in the alternative embodiment the electrically conducting coating is a metallic or metal oxide, thin and largely transparent layer produced in vacuo or pyrolytically, which preferably has a sheet resistance of 5 mΩ to 3,000Ω/square, particularly preferably a sheet resistance of 0.1 to 1,000Ω/square, most particularly preferably 5 to 30Ω/square, and in a further preferred embodiment has a daylight transmissibility at least greater than 60% (>60 to 100%) and in particular greater than 76% (>76 to 100%).

Furthermore electrically conducting glass can also be used as electrode.

A particularly preferred type of electrically conducting and highly transparent glass, in particular float glass, are pyrolytically produced layers that have a high surface hardness and whose electrical surface resistance can be adjusted in a very wide range from in general a few milliohms up to 3,000Ω/square.

Such pyrolytically coated glasses can be readily shaped/formed and have a good scratch resistance, and in particular scratches do not lead to an electrical interruption of the electrically conducting surface layer, but simply to a generally slight increase of the sheet resistance.

Furthermore, pyrolytically produced conducting surface layers are due to the heat treatment diffused to such a large extent and anchored in the surface that in a subsequent material application an extremely high adhesive bonding with the glass substrate is produced, which is likewise very advantageous for the present invention. In addition such coatings have a good homogeneity, and therefore only a slight variation in the surface resistance over large surfaces. This property is likewise an advantage for the present invention.

Electrically conducting and highly transparent thin layers can be produced substantially more efficiently and cost-effectively on a glass substrate, which is preferably used according to the invention, than on polymeric substrates such as PET, PMMA or PC. The electrical sheet resistance in the case of glass coatings is on average more favourable by a factor of 10 than on a polymeric film of comparable transparency, thus for example 3 to 10Ω/square in the case of glass layers compared to 30 to 100Ω/square on PET films.

The rear electrode component BE is—as in the case of the at least partially transparent electrode—a flat electrode, which however need not be transparent or at least partially transparent. This is in general applied to the insulating layer, if present. If no insulating layer is present, then the rear electrode is applied to the layer containing at least one luminous substance that can be excited by an electrical field. In an alternative embodiment the rear electrode is applied to the substrate A.

The rear electrode is in general formed from electrically conducting materials based on inorganic or organic substances, for example from metals such as silver, wherein preferably those materials are used that are not damaged if the isostatic high-pressure forming process is used to produce the three-dimensionally formed sheet element according to the invention. Suitable electrodes include furthermore in particular polymeric electrically conducting coatings. In this case the coatings already mentioned in connection with the at least partially transparent electrode can be used. Moreover, those polymeric electrically conducting coatings known to the person skilled in the art that are not at least partially transparent, can be employed.

The formulation of the printing paste for the rear electrode can in this connection correspond to that of the partially transparent electrode.

By way of departure from this formulation, the following formulation can however also be used according to the invention for the rear electrode.

30 to 90 wt. %, preferably 40 to 80 wt. %, particularly preferably 50 to 70 wt. %, in each case referred to the total weight of the printing paste, of the conducting polymers Clevios P, Clevios PH, Clevios P AG, Clevios P HCV4, Clevios P HS, Clevios PH, Clevios PH 500, Clevios PH 510 or arbitrary mixtures thereof, are used for the formulation of a printing paste for the production of the rear electrode. Dimethyl sulfoxide (DMSO), N,N-dimethylformamide, N,N-dimethylacetamide, ethylene glycol, glycerol, sorbitol, methanol, ethanol, isopropanol, n-propanol, acetone, methyl ethyl ketone, dimethylaminoethanol, water or mixtures of two, three or more of these solvents can be used as solvent. The amount of solvent that is used can vary in wide ranges. Thus, one formulation of a paste according to the invention can contain 55 to 60 wt. % of solvent, whereas in another formulation according to the invention about 40 wt. % of a solvent mixture of three solvents is used. Furthermore, Silquest A187, Neo Rez R986, Dynol 604 or mixtures of two or more of these substances can be used as surfactant additive and bonding activator, preferably in an amount of 0.7 to 1.2 wt. %. The formulation can contain for example 0.5 to 1.5 wt. % of UD-85, Bayhydrol PR340/1, Bayhydrol PR135 or arbitrary mixtures thereof as binder.

In a further embodiment according to the invention the rear electrode can be filled with graphite. This can be accomplished by adding graphite to the formulations described above.

By way of departure from the formulation mentioned above for the rear electrode, the following ready-for-use, commercially obtainable printing pastes already mentioned here by way of example can also be used according to the invention: the Orgacon EL-P1000, EL-P3000, EL-P5000 or EL-P6000 range from Agfa, preferably the EL-P3000 and EL-P6000 range (for formable uses). Graphite can also be added in this case.

The printing pastes of the Orgacon EL-P4000 range, in particular Orgacon EL-P4010 and EL-4020, can also be used specifically for the rear electrode. Both can be mixed with one another in any desired ratio. Orgacon EL-P4010 and EL-4020 already contain graphite.

Graphite pastes that can also be obtained commercially, for example graphite pastes from Acheson, in particular Electrodag 965 SS or Electrodag 6017 SS, can be used as rear electrode.

A particularly preferred formulation according to the invention of a printing paste for producing the rear electrode BE contains:

| Substance | Content/wt.-% | Content/wt.-% | Content/wt.-% |
|---|---|---|---|
| Clevios P HS | 58.0 | 50.7 | 64.0 |
| Silquest A187 | 2.0 | 1.0 | 1.6 |
| NMP (e.g. BASF) | 17.0 | 12.1 | 14.8 |
| DEG | 10.0 | 23.5 | 5.9 |
| DPG/DMM | 10.0 | 8.6 | 10.2 |
| Bayderm Finish | 3.0 | 4.1 | 3.5 |
| 85 UD (Lanxess) | | | |

| Substance | Content/wt.-% | Content/wt.-% |
|---|---|---|
| Clevios P HS | 58.0 | 50.7 |
| Silquest A187 | 2.0 | 1.0 |
| NMP (e.g. BASF) | 17.0 | 12.1 |
| DEG | 10.0 | 23.5 |
| DPG/DMM | 10.0 | 8.6 |
| Bayhydrol P340/1 | 3.0 | 4.1 |

Conducting Tracks, Connections of the Electrodes

In the case of large area luminous elements with a luminous capacitor structure, the surface conductivity plays a significant role as regards a uniform luminous density. In the case of large area luminous elements so-called busbars are frequently used as conducting tracks, i.e. component BF, especially with semiconducting LEPs(light-emitting polymers), PLED and/or OLED systems, in which relatively large currents flow. In this case very highly electrically conducting tracks are formed in the manner of a cross. In this way a large surface area for example is subdivided into four small areas. The voltage drop in the middle region of a luminous surface is thereby significantly reduced and the uniformity of the luminous density and the decrease in brightness in the centre of a luminous field is reduced.

In the case of a zinc sulfide particular EL field employed in one embodiment according to the invention, in general alternating voltages greater than 100 volts and up to more than 200 volts are applied, and very low currents flow if a good dielectric material or good insulation are employed. In the ZnS thick-film AC-EL element according to the invention the problem of current loading is therefore substantially less than in the case of semiconducting LEP or OLED systems, so that the use of busbars is not absolutely essential, but instead large area luminous elements can already be installed without using busbars.

Preferably according to the invention it is sufficient if the silver bus in the case of areas smaller than DIN A3 is printed only on the edge of the electrode layer BA or BE; with areas larger than DIN A3 it is preferred according to the invention if the silver bus fauns at least an additional conducting track.

The electrical connections can be produced for example by using electrically conducting and stovable pastes containing tin, zinc, silver, palladium, aluminium and further suitable conducting metals, or combinations and mixtures or alloys thereof.

In this connection the electrically conducting contacting strips are generally applied by means of screen printing, brush application, ink-jet, knife coating, roller application, spraying, or by means of dispenser application or comparable application methods known to the person skilled in the art, to the electrically conducting and at least partially transparent thin coatings, and are then generally heat treated in an oven so that strips normally applied laterally along a substrate edge can be effectively contacted in an electrically conducting manner by means of soldering, clamping or plug-in type connection.

So long as only very small electrical outputs have to be initiated on electrically conducting coatings, spring contacts or carbon-filled rubber elements or so-called zebra rubber strips are sufficient. Pastes based on silver, palladium, copper or gold-filled polymer adhesives are preferably used as conducting adhesive pastes. Self-adhesive, electrically conducting strips of for example tin-plated copper foil with an electrically conducting adhesive in the z-direction can likewise be applied by contact pressing.

The adhesive layer is in this case generally uniformly pressed in by exerting a surface pressure of a few N/cm², and depending on the implementation, values of 0.013 Ω/cm² (for example conductive copper foil tape VE 1691 from the company D & M International, A-8451 Heimschuh) or 0.005Ω (for example type 1183 from 3M Electrical Products Division, Austin, Tex. USA; according to MIL-STD-200 Method 307 maintained at 5 psi/3.4 N/cm² measured over 1 sq.in. surface area) or 0.001Ω (for example type 1345 from the 3M company) or 0.003Ω (for example type 3202 from the company Holland Shielding Systems BV) are thereby achieved.

The contacting can however be carried out by all conventional methods known to the person skilled in the art, for example crimping, plugging in, clamping, riveting or bolting/screwing.

Dielectric Layer

The EL element according to the invention preferably comprises at least one dielectric layer, component BD, which is provided between the rear electrode, component BE, and the EL layer, component BC.

Suitable dielectric layers are known to the person skilled in the art. Suitable layers often include highly dielectrically acting powders, such as for example barium titanate, which are preferably dispersed in fluorene-containing plastics or in cyano-based resins. Examples of particularly suitable particles are barium titanate particles in the range of preferably 1.0 to 2.0 μm. With a high degree of filling these can produce a relative dielectric constant of up to 100.

The dielectric layer has a thickness of generally 1 to 50 μm, preferably 2 to 40 μm, particularly preferably 5 to 25 μm, especially 8 to 15 μm.

The EL element according to the invention can in one embodiment also additionally contain a further dielectric layer, which layers are arranged above one another and together improve the insulation effect, or which is interrupted by a floating electrode layer. The use of a second dielectric layer can depend on the quality and pinhole freedom of the first dielectric layer.

As fillers, inorganic insulating materials are used, which are known to the person skilled in the art from the literature and include for example: BaTiO₃, SrTiO₃, KNbO₃, PbTiO₃, LaTaO₃, LiNbO₃, GeTe, Mg₂TiO₄, Bi₂(TiO₃)₃, NiTiO₃, CaTiO₃, ZnTiO₃, Zn₂TiO₄, BaSnO₃, Bi(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ and lead zirconate-titanate mixed crystals or mixtures of two or more of these fillers. Preferred fillers according to the invention are BaTiO₃ or PbZrO₃ or mixtures thereof, preferably in filling amounts of 5 to 80 wt. %, preferably 10 to 75 wt. %, particularly preferably 40 to 70 wt. %, in each case referred to the total weight of the paste, in the paste used to produce the insulating layer.

One-component or preferably two-component polyurethane systems can be used as binder for this layer, preferably the systems available from Bayer MaterialScience AG, particularly preferably Desmodur and Desmophen or the lacquer raw materials of the Lupranate, Lupranol, Pluracol or Lupraphen range from BASF AG; from Degussa AG (Evonik), preferably vestanate, particularly preferably vestanate T and B; or from the Dow Chemical Company, preferably vorastar.

Furthermore highly flexible binders can also be used, for example those based on PMMA, PVA, in particular mowiol and poval from Kuraray Specialties Europe GmbH or polyviol from Wacker AG, or PVB, in particular mowital from Kuraray Specialties Europe GmbH (B 20 H, B 30 T, B 30 H, B 30 HH, B 45 H, B 60 T, B 60 H, B 60 HE, B 75 H), or pioloform, in particular pioloform BR18, BM18 or BT18, from Wacker AG.

As solvents there may for example be used ethyl acetate, butyl acetate, 1-methoxypropyl acetate-2, toluene, xylene, solvesso 100, shellsol A or mixtures of two or more of these solvents. If for example PVB is used as binder, the paste can also contain methanol, ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane, as well as mixtures of two or more of the aforementioned solvents, in amounts of 1 to 30 wt. % referred to the total weight of the paste, preferably 2 to 20 wt. %, particularly preferably 3 to 10 wt. % Furthermore additives such as flow improvers and rheology additives can be added in order to improve the properties. Examples of flow improvers are Additol XL480 in butoxyl in a mixing ratio of 40:60 to 60:40. The paste can contain as further additives 0.01 to 10 wt. %, preferably 0.05 to 5 wt. %, particularly preferably 0.1 to 2 wt. %, in each case referred to the total weight of paste. As rheology additives, which reduce the settling behaviour of pigments and fillers in the paste, there can for example be used BYK 410, BYK 411, BYK 430, BYK 431 or arbitrary mixtures thereof.

Particularly preferred formulations according to the invention of a printing paste for the production of the insulating layer as component BB and/or BD contain:

| Substance | Content/wt. % | Content/wt. % | Content/wt. % | Content/wt. % |
|---|---|---|---|---|
| BaTiO₃ | 50 | 50 | 50 | 55 |
| Desmophen | 25 | 25 | 25 | 22.5 |
| 1800 (BMS) | | | | |
| Desmodur | 14 | 14 | 14 | 11.4 |
| L67 MPA/X (BMS) | | | | |
| Ethoxypropyl | 8.7 | 0 | 4 | 0 |
| acetate | | | | |
| Methoxypropyl | 0 | 8.7 | 4.7 | 8.6 |
| acetate | | | | |
| Additol XL480 | 2.3 | 2.3 | 2.3 | 2.5 |
| (50 wt. % | | | | |
| in butoxyl) | | | | |

| Substance | Content/wt. % | Content/wt. % | Content/wt. % | Content/wt. % |
|---|---|---|---|---|
| BaTiO₃ | 55 | 56.6 | 59.9 | 59.9 |
| Desmophen | 22.5 | 20.3 | 19.9 | 19.9 |
| 1800 (BMS) | | | | |
| Desmodur | 11.4 | 12.5 | 11.2 | 11.2 |
| L67 MPA/X (BMS) | | | | |
| Ethoxypropyl | 8.6 | 7.6 | 5.7 | 0 |
| acetate | | | | |
| Methoxypropyl | 0 | 0 | 0 | 5.7 |
| acetate | | | | |
| Additol XL480 in | 2.5 | 3.0 | 3.3 | 3.3 |
| butoxyl 50% | | | | |

| Substance | Content/wt. % | Substance | Content/wt. % |
|---|---|---|---|
| BaTiO₃ | 55 | BaTiO₃ | 60.2 |
| Desmophen | 22.5 | Desmophen | 14.3 |
| 1800 (BMS) | | 670 (BMS) | |
| Desmodur L67 | 12 | Desmodur | 12.3 |
| MPA/X (BMS) | | N75MPA (BMS) | |
| Ethoxypropyl | 8 | Ethoxypropyl | 10.3 |
| acetate | | acetate | |
| Additol XL480 | 2.5 | Additol XL480 | 2.9 |
| (50 wt. % in | | (50 wt. % in | |
| butoxyl) | | butoxyl) | |

EL Layer

The EL element according to the invention includes at least one EL layer, component BC. The at least one EL layer can be manged on the whole internal surface of the first partially transparent electrode or on one or more partial surfaces of the first at least partially transparent electrode. In the case where the EL layer is arranged on several partial surfaces, the partial surfaces generally have a mutual interspacing of 0.5 to 10.0 mm, preferably 1 to 5 mm.

The EL layer is in general composed of a binder matrix with EL pigments homogeneously dispersed therein. The binder matrix is generally chosen so as to produce a good adhesive bonding to the electrode layer (or to the dielectric layer optionally applied thereto). In a preferred configuration PVB- or PU-based system are used in this connection. In addition to the EL pigments optionally further additives may also be present in the binder matrix, such as colour-converting organic and/or inorganic systems, colorant additives for a daytime and nighttime light effect and/or reflecting and/or light-absorbing effect pigments such as aluminium flakes, glass flakes or mica platelets.

The El pigments used in the EL layer generally have a thickness of 1 to 50 μm, preferably 5 to 25 μm.

Preferably the at least one EL layer BC is an alternating current thick-film powder electroluminescent (AC-P-EL) luminous structure.

Thick-film AC-EL systems have been well known since Destriau in 1947, and are applied to ITO-PET films generally by means of screen printing. Since zinc sulfide electroluminophores experience a very high degradation in operation and specifically at elevated temperatures and in a water vapour atmosphere, nowadays in general microencapsulated EL pigments are used for long-life thick-film AC-EL lamp structures. It is however also possible to use non-microencapsulated pigments in the EL element according to the invention, as is discussed further hereinafter.

EL elements are understood in the context of the present invention to mean thick-film EL systems that are operated by means of alternating voltage at normally 100 volts and 400 Hz and in this way emit a so-called cold light of a few cd/m² up to several 100 cd/m². EL screen printing pastes are generally used in such inorganic thick-film alternating voltage EL elements.

Such EL screen printing pastes are generally formulated on the basis of inorganic substances. Suitable substances are for example highly pure ZnS, CdS, ZnₓCd₁₋ₓS compounds of groups II and

IV of the Periodic System of the Elements, ZnS being particularly preferably used. The aforementioned substances can be doped or activated and optionally also co-activated. Copper and/or manganese for example are used for the doping. The co-activation is carried out for example with chlorine, bromine, iodine and aluminium. The content of alkali metals and rare earth metals in the aforementioned substances is generally very low, if these are present at all. Most particularly preferably ZnS is used, which is preferably doped or activated with copper and/or manganese and is preferably co-activated with chlorine, bromine, iodine and/or aluminium. Normal EL emission colours are yellow, orange, green, green-blue, blue-green and white, the emission colours white or red being able to be obtained by mixtures of suitable EL pigments or by colour conversion. The colour conversion can generally be implemented in the form of a converting layer and/or by admixture of appropriate dyes and pigments in the polymeric binder of the screen printing inks or in the polymeric matrix in which the EL pigments are incorporated.

In a further embodiment of the present invention the screen printing matrix used for the production of the EL layer is provided with glazing, colour-filtering or colour-converting dyes and/or pigments. The emission colour white or a day/night light effect can be generated in this way. In a further embodiment pigments are used in the EL layer that have an emission in the blue wavelength range from 420 to 480 nm and are provided with a colour-converting microencapsulation. The colour white can be emitted in this way.

In one embodiment, as pigments in the EL layer AC-P-EL pigments are used that have an emission in the blue wavelength range from 420 to 480 nm. In addition the AC-P-EL screen printing matrix preferably contains wavelength-converting inorganic fine particles based on europium(II)-activated alkaline earth orthosilicate luminous pigments such as (Ba, Sr, Ca)₂SiO₄:Eu²⁺ or YAG luminous pigments such as Y₃Al₅O₁₂:Ce³⁺ or Tb₃Al₅O₁₂:Ce³⁺ or Sr₂GaS₄:Eu²⁺ or SrS:Eu²⁺ or (Y,Lu,Gd,Tb)₃(Al,Sc,Ga)₅O₁₂:Ce³⁺ or (Zn,Ca,Sr)(S,Se):Eu²⁺. A white emission can also be achieved in this way.

Corresponding to the prior art the aforementioned EL pigments can be microencapsulated. Due to the inorganic microencapsulation techniques good half-life times can be achieved. The EL screen printing system Luxprint® for EL from E.I. du Pont de Nemours and Companies may be mentioned here by way of example. Organic microencapsulation techniques and film-wrap laminates based on the various thermoplastic films are in principle also suitable, but have however proved to be expensive and do not significantly prolong the service life.

Suitable zinc sulfide microencapsulated EL luminous pigments are available from Osram Sylvania, Inc. Towanda under the trade names GlacierGLO™ Standard, High Brite and Long Life, and from the Durel Division of the Rogers Corporation under the trade names 1PHS001® High-Efficiency Green Encapsulated EL Phosphor, 1PHS002® High-Efficiency Blue-Green Encapsulated EL Phosphor, 1PHS003® Long-Life Blue Encapsulated EL Phosphor, 1PHS004® Long-Life Orange Encapsulated EL Phosphor.

The mean particle diameters of the suitable microencapsulated pigments in the EL layer are in general 15 to 60 μm, preferably 20 to 35 μm.

Non-microencapsulated fine grain EL pigments, preferably with a high service life, can also be used in the EL layer of the EL element according to the invention. Suitable non-microencapsulated fine grain zinc sulfide EL pigments are disclosed for example in U.S. Pat. No. 6,248,261 and in WO 01/34723. These preferably have a cubic crystal lattice structure. The non-microencapsulated pigments preferably have mean particle diameters of 1 to 30 μm, particularly preferably 3 to 25 μm, most particularly preferably 5 to 20 μm.

Specifically, non-microencapsulated EL pigments with smaller pigment dimensions down to below 10 μm can be used. The transparency of the glass element can be increased in this way.

Thus, unencapsulated pigments can be admixed with the suitable screen printing inks according to the present invention, preferably having regard to the special hygroscopic properties of the pigments, preferably the ZnS pigments. In this connection in general binders are used that on the one hand have a good adhesion to so-called ITO layers (indium-tin oxide layers) or to intrinsically conducting polymeric transparent layers, and that on the other hand have a good insulating effect, strengthen the dielectric and thereby effect an improvement of the breakdown strength at high electric field strengths, and in addition in the cured state exhibit a good water vapour barrier effect and additionally protect the EL pigment and prolong the service life.

In one embodiment of the present invention pigments that are not microencapsulated are used in the AC-P-EL luminous layer.

The half-life times of the suitable pigments in the EL layer, i.e. the time during which the initial brightness of the EL element according to the invention has fallen by half, are in general at 100 volts and 80 volts and 400 Hz, 400 hours to at most 5,000 hours, but normally however not more than 1,000 to 3,500 hours.

The brightness values (EL emission) are in general 1 to 200 cd/m², preferably 3 to 100 cd/m², particularly preferably 5 to 40 cd/m²; with large luminous surface areas the brightness values are preferably in the range from 1 to 50 cd/m².

Pigments with longer or shorter half-life times and higher or lower brightness values can however also be used in the EL layer of the EL element according to the invention.

In a further embodiment of the present invention the pigments present in the EL layer have such a small mean particle diameter, or such a low degree of filling in the EL layer, or the individual EL layers are configured geometrically so small, or the interspacing of the individual layers is chosen so large, that the EL element in the case of non-electrically activated luminous structures is configured to be at least partially transparent or to ensure transmissibility. Suitable pigment particle diameters, degrees of filling, dimensions of the luminous elements and interspacings of the luminous elements have been mentioned hereinbefore.

The layer contains the aforementioned, optionally doped ZnS crystals, preferably microencapsulated as described above, preferably in an amount of 40 to 90 wt. %, more preferably 50 to 80 wt. %, particularly preferably 55 to 70 wt. %, in each case referred to the weight of the paste. One-component and preferably two-component polyurethanes can be used as binder. Preferred according to the invention are highly flexible materials from Bayer MaterialScience AG, for example the lacquer raw materials of the Desmophen and Desmodur ranges, preferably Desmophen and Desmodur, or the lacquer raw materials of the Lupranate, Lupranol, Pluracol or Lupraphen ranges from BASF AG. As solvents, ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or arbitrary mixtures of two or more of these solvents can be used in amounts of preferably 1 to 50 wt. %, preferably 2 to 30 wt. %, particularly preferably 5 to 15 wt. %, in each case referred to the total amount of paste. Furthermore other highly flexible binders, for example those based on PMMA, PVA, in particular mowiol and poval from Kuraray Europe GmbH (now called Kuraray Specialties) or polyviol from Wacker AG, or PVB, in particular mowital from Kuraray Europe GmbH (B 20 H, B 30 T, B 30 H, B 30 HH, B 45 H, B 60 T, B 60 H, B 60 HH, B 75 H), or pioloform, in particular pioloform BR18, BM18 or BT18, from Wacker AG, can be used. When using polymeric binders such as for example PVB, solvents such as methanol, ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane as well as mixtures of two or more of the aforementioned solvents can furthermore be added in amounts of 1 to 30 wt. % referred to the total weight of the paste, preferably 2 to 20 wt. %, particularly preferably 3 to 10 wt. %.

In addition 0.1 to 2 wt. % of additives can be included in order to improve the flow behaviour and the flow. Examples of flow improvers are Additol XL480 in butoxyl in a mixing ratio of 40:60 to 60:40. As further additives 0.01 to 10 wt. %, preferably 0.05 to 5 wt. %, particularly preferably 0.1 to 2 wt. %, in each case referred to the total weight of the paste, of rheology additives can be included, which reduce the settling behaviour of pigments and fillers in the paste, for example BYK 410, BYK 411, BYK 430, BYK 431 or arbitrary mixtures thereof.

Particularly preferred formulations according to the invention of printing pastes for the production of the EL luminous pigment layer as component BC contain:

| Substance | Content/wt. % | Content/wt. % | Content/wt. % | Content/wt. % |
|---|---|---|---|---|
| Pigment | 55.3 | 69.7 | 64.75 | 65.1 |
| (Osram Sylvania) | | | | |
| Desmophen | 18.5 | 11.9 | 12.7 | 13.1 |
| D670 (BMS) | | | | |
| Desmodur | 16.0 | 9.0 | 12.4 | 11.3 |
| N75 MPA (BMS) | | | | |
| Ethoxypropyl | 9.8 | 9.1 | 9.9 | 10.2 |
| acetate | | | | |
| Additol XL480 | 0.4 | 0.3 | 0.25 | 0.3 |
| (50 wt. % | | | | |
| in butoxyl) | | | | |

| Substance | Content/wt. % | Content/wt. % | Content/wt. % |
|---|---|---|---|
| Pigment | 61.2 | 65.1 | 69.7 |
| (Osram Sylvania) | | | |
| Desmophen | 15.2 | 12.7 | 11.9 |
| D670 (BMS) | | | |
| Desmodur | 13.1 | 11.4 | 9.0 |
| N75 MPA (BMS) | | | |
| Methoxypropyl | 10.2 | 5.5 | 4.9 |
| acetate | | | |
| Ethoxypropyl | 0 | 5 | 4.2 |
| acetate | | | |
| Additol XL480 | 0.3 | 0.3 | 0.3 |
| (50 wt. % | | | |
| in butoxyl) | | | |

| Substance | Content/wt. % | Content/wt. % |
|---|---|---|
| Pigment | 61.2 | 69.7 |
| (Osram Sylvania) | | |
| Desmophen | 17.7 | 14.1 |
| 1800 (BMS) | | |
| Desmodur | 9.9 | 7.9 |
| L67 MPA/X (BMS) | | |
| Ethoxypropyl | 10.8 | 8.0 |
| acetate | | |
| Additol XL480 | 0.4 | 0.3 |
| (50 wt. % | | |
| in butoxyl) | | |

Cover Layer

In addition to the components A and B the EL element according to the invention contains a protective layer, component CA, in order to prevent a destruction of the electroluminescent element or of the possibly present graphical representations. Suitable materials for the protective layer are known to the person skilled in the art. Suitable protective layers CA are for example high temperature resistant protective lacquers such as protective lacquers containing polycarbonates and binders. An example of such a protective lacquer is Noriphan® HTR from Pröll, Weilβenburg.

Alternatively the protective layer can also be formulated on the basis of flexible polymers such as polyurethanes, PMMA, PVA or PVB. Polyurethanes from Bayer MaterialScience AG can be used for this purpose. This formulation can also be provided with fillers. All fillers known to the person skilled in the art are suitable for this purpose, for example based on inorganic metal oxides such as TiO₂, ZnO, lithopones, etc., with a degree of filling of 10 to 80 wt. % of the printing paste, preferably a degree of filling of 20 to 70%, particularly preferably of 40 to 60%. Furthermore the formulations can contain flow improvers as well as rheology additives. As solvents there can be used for example ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or mixtures of two or more of these solvents.

According to the invention particularly preferred formulations of the protective lacquer CA contain for example:

| Substance | Content/wt. % | Content/wt. % | Content/wt. % | Content/wt. % |
|---|---|---|---|---|
| Desmophen | 18.9 | 22.0 | 17.3 | 22.0 |
| 670 (BMS) | | | | |
| Additol | 1.2 | 0.8 | 1.0 | 0.8 |
| XL480 | | | | |
| (50 wt. % | | | | |
| in butoxyl) | | | | |
| Desmodur | 20.0 | 20.0 | 17.4 | 20.0 |
| N75 MPA (BMS) | | | | |
| Ethoxypropyl | 4.5 | 8.5 | 4.3 | 0 |
| acetate | | | | |
| Methoxypropyl | 0 | 0 | 0 | 8.5 |
| acetate | | | | |
| TiO₂ | 55.4 | 48.7 | 60.0 | 48.7 |

| Substance | Content/wt. % |
|---|---|
| Desmophen | 22.9 |
| 1800 (BMS) | |
| Additol XL480 | 1.1 |
| (50 wt. % | |
| in butoxyl) | |
| Desmodur | 12.9 |
| L67 MPA/X (BMS) | |
| Ethoxypropyl | 10.6 |
| acetate | |
| TiO₂ | 52.5 |

Substrates

The EL element according to the invention can comprise on one or both sides of the respective electrodes, substrates such as for example glasses, plastics films or the like, in addition to the textile carrier material.

In the EL element according to the invention it is preferred if at least the substrate that is in contact with the transparent electrode is designed to be graphically glazingly translucent and opaquely covering on the inside. An opaque covering design is understood to mean a large area electroluminescence region that is opaquely covered by a high-resolution graphical design and/or is formed glazingly, for example in the sense of red-green-blue, translucently for signalling purposes.

In addition it is preferred if the substrate that is in contact with the transparent electrode BA is a film that is cold-stretchably workable below the glass transition temperature Tg. In this way the possibility is provided of working the resulting EL element three-dimensionally.

Furthermore it is preferred if the substrate that is in contact with the rear electrode BE is a film that is likewise cold-stretchably workable below Tg. In this way the possibility is provided of working the resulting EL element three-dimensionally.

The EL element is thus three-dimensionally workable, wherein the radii of curvature may be less than 2 mm, preferably less than 1 mm The working angle can in this connection be greater than 60°, preferably greater than 75°, particularly preferably greater than 90° and especially greater than 105°.

Moreover it is preferred if the EL element is three-dimensionally workable and in particular is cold-stretchably workable below Tg and in this way receives a precise, worked three-dimensional shape.

The three-dimensionally worked element can be moulded on at least one side with a thermoplastic material in an injection mould.

Production of EL Elements According to the Invention

Normally the pastes mentioned hereinbefore (screen printing pastes) are applied to transparent plastics films or glasses, which in turn comprise a largely transparent electrically conducting coating and thereby form the electrode for the visual display side. The dielectric material, if present, and the rear side electrode are then produced by printing techniques and/or lamination techniques.

A reverse production process is however also possible, in which first of all the rear side electrode is produced or the rear side electrode is used in the form of a metallised film and the dielectric material is applied to this electrode. The EL layer and following this the transparent and electrically conducting upper electrode are then applied. The resultant system can then optionally be laminated with a transparent cover film and thereby protected against water vapour and also against mechanical damage.

In one embodiment of the invention the conducting tracks (silver bus) can be applied as first layer to the substrate A. According to the invention they are however preferably applied to the electrodes BA and BE either in two work stages, in each case individually to the electrodes, or in one work step to the electrodes jointly.

The EL layer is normally applied by a printing technique by means of screen printing or dispenser application or ink-jet application, or also in a knife coating procedure or a roller coating method or a curtain casting method or a transfer method, but preferably by means of screen printing. The EL layer is preferably applied to the surface of the electrode or to the insulating layer optionally applied to the rear electrode.

Textile Carrier Material

The electroluminescent arrangement according to the invention includes at least one textile carrier material.

The choice of suitable textile carrier materials is not subject to any particular restriction and the textile carrier material can be selected from a plurality of normally employed textile materials.

Thus, the fibre material of corresponding textile carrier materials can be chosen for example from the group consisting of plant fibres, fibres of animal origin, mineral fibres, chemical fibres, fibres of natural polymers, fibres of synthetic polymers, inorganic chemical fibres and in addition leather.

If a textile carrier material of plant fibres is used in the present invention, then the plant fibres can for example be selected from the group consisting of seed fibres such as cotton, i.e. fibres from the seed hairs of the fruit of the cotton plant; kapok, i.e. fibres from the interior of the seed case fruit of the kapok tree; poplar down; bast fibres such as bamboo fibres, stinging nettle (nettle cloth), hemp, jute, linen, i.e. fibres from the flax plant, ramie (Chinese grass); hard fibres such as wood fibres, sisal, i.e. fibres from the leaves of the sisal agave, manila, hard fibres from the leaves of a type of banana; fruit fibres such as coconut, i.e. fibres from the fruit shell of the coconut palm fruit; and fibres from rush grasses.

If a textile carrier material of fibres of animal origin is used in the present invention, then the fibres of animal origin can for example be selected from the group consisting of wools and fine animal hairs, such as wool from sheep (e.g. shearing wool), alpaca, llama, vicuna, guanaco, angora (hair from the agora rabbit), rabbit (normal rabbit hair), cashmere, merino wool, camel hair, mohair, goat hair, cattle hair (e.g. hair from the yak), horse hair, silks such as mulberry silk (cultivated silk), tussore silk and mussel silk.

If a textile carrier material of mineral fibres is used in the present invention, then the mineral fibres may be selected for example from the group consisting of fibres without organically bound carbon, such as asbestos.

If a textile carrier material of fibres of natural polymers is used in the present invention, then the fibres may for example be selected from the group consisting of cellulose fibres, such as viscose, modal, lyocell, cupro, acetate, triacetate, paper fibres, bamboo fibre regenerated material, and cellulon; rubber fibres such as rubber; plant protein fibres; and animal protein fibres such as casein.

If a textile carrier material of fibres of synthetic polymers is used in the present invention, then the fibres may be selected for example from the group consisting of polycondensation fibres such as polyesters (PES), in particular polyethylene terephthalate (PET), polyamide (PA) and aramide; polymerisation fibres such as polyacrylonitrile (PAN), polytetrafluoroethylene, polyethylene (PE), polypropylene (PP), polyvinyl chloride (termed CLF in the case of fibres, otherwise PVC); and polyaddition fibres such as polyurethane (PU).

If a textile carrier material of inorganic chemical fibres is used in the present invention, then the fibres may for example be glass fibres.

Furthermore, carbon fibres, metal fibres (MTF), ceramic fibres and nanotube fibres are also suitable.

Apart from the fibre-containing materials described above, textile materials made of leather and imitation leather are also suitable as carrier material in the electroluminescent arrangement according to the invention. Leather is a skin or dermal layer, with or without hair or wool, chemically cured and preserved by tanning, the original fibrous structure of which is retained. Leather is mostly obtained from the corium, the so-called dermal layer. This in turn is subdivided into the outwardly lying capillary layer, which gives the surface of the leather its appearance, and the underlying reticular layer. The person skilled in the art speaks of a skin or a hide, depending on the size of the animal skin from which the leather is obtained.

Depending on the production of the textile leather materials, a distinction is made between harness leather, chrome-tanned leather, plant-tanned leather, rhubarb-tanned leather, chamois leather, split hide leather, alum-tanned leather and full leather, wherein in the scope of the present invention textile materials based on all these types of leather materials can be used.

Depending on the surface treatment a distinction is made between dyed leather, kidskin, “chicken” leather, patent leather, nubuk leather, suede leather, black leather, velour leather and buckskin, wherein in the scope of the present invention textile materials based on all these types of leather materials can be used.

In addition buckskin or imitation leather can also be used.

As a rule imitation leather is understood to be a textile fabric composite with a coating of plastics material. The fabric is a natural fibre fabric or fabric made of synthetic fibres, which is coated with a soft PVC layer. These coatings can, depending on the particular application, be formed so as to be compact or expanded. In all cases the surfaces are also grained or corned, so that they resemble a leather structure. Imitation leathers can also have a polyurethane coating instead of the PVC coating.

The textile carrier material can also be in the form of a knitted fabric, woven fabric, woven/non-woven or a fleece.

According to a preferred implementation the carrier material is a textile carrier material, such as is used for example for the roof of a vehicle or for other items and objects in the interior of the vehicle.

In a particularly preferred embodiment the textile carrier material is a material such as is used for example for a folding top of a convertible or for a seat cover.

Further possible textile carrier materials are articles of clothing, sportsgear and the like.

Moreover, textile carrier materials can also be used that are employed for example as large-size advertising carriers. They serve in this connection to advertise various products, as an art object, to publicise events, in the manner of an information board, as a temporary cladding for a building during renovation, reconstruction or the like. Advertising carriers made of textile material have proved advantageous in this connection, in particular on account of their better properties compared to paper, cardboard, plastics or other materials. These properties include weathering resistance, tear resistance, no tendency to form corrugations or discolouration/fading of the colours, and the good printability also in the case of large-size advertising carriers. It is also known to coat advertising carriers with metal in order to produce certain optical effects and to impart to the information carrier as a whole a pleasing appearance, which is somewhat comparable to the metallic effect achieved with an automobile paint coat.

The textile carrier material used according to the invention is generally a flat element, which has a light transmittance in the visible wavelength range of at least 40%, in particular however more than 50%. The textile carrier material optionally has small holes or sites of reduced thickness, so that in this way a special light transmittance or transparency is produced. It is also possible for the carrier material formed as a flat element to be provided with patterns and to have a corresponding surface structure or etching or embossing. Also, a coloured design is possible, in which connection a bright or translucent or glazed colour effect is preferably employed in the region of electroluminescence fields.

The side of the textile carrier material on which the electroluminescent arrangement is provided, is preferably implemented so that an adhesive bonding is possible with a thermoplastic film or layer or with a layer of a heat-sealable adhesive agent or a heat-sealable fleece.

Composite Formed Between the Electroluminescent System and Textile Carrier Material

The individual constituents of the electroluminescent arrangement according to the invention, namely the at least one flexible textile carrier material and the at least one flexible electroluminescent element, are joined to one another, and are preferably bonded. The adhesive bond between the textile carrier material and the electroluminescent arrangement is in this connection preferably effected by means of an adhesive layer formed from TPU, which is provided between the cover electrode (component E) and the textile carrier material. The electroluminescence emission is then transmitted through the cover electrode and the textile carrier material.

A TPU layer is understood to mean for example films obtainable from Epurex Film (Bayer MaterialScience Company) with the trade marks Dureflex®, Platilon® and Walopur®. Such films are used with and without a carrier film and have film thicknesses of in general 0.01 to 2.00 mm, in particular 0.02 to 0.50 mm, particularly preferably 0.05 to 0.40 mm, most particularly preferably 0.10 to 0.40 mm and especially 0.15 to 0.40 mm

Such a TPU film has a significantly smaller dimensional stability, so that textile carrier materials provided with such a film can easily be worked in a flexible manner. Moreover, at elevated temperatures these TPU films—compared to corresponding films of polycarbonate or polyethylene terephthalate—are likewise formed less dimensionally stable, so that preferably a special electroluminescent layer system is preferred as regards the production of the various screen printings and most specifically as regards the drying temperatures of the individual electroluminescent layers.

In preferred embodiments of the present invention relatively heat-resistant TPU films are therefore used, for example those identified as Dureflex® A 4700 Optical Aliphatic Polyether Polyurethane Grade films from the Deerfield Urethane company, a Bayer MaterialScience company, or highly elastic polyurethane films with the identification Platilon® and Walopur® from the epurex films company, a Bayer MaterialScience company. The corresponding electroluminescent layers are applied preferably by means of screen printing to these films. The TPU film can then be laminated with the TPU film side onto the tissue and an elastic layer such as a TPU or TPE film can be laminated or printed onto the rear-side electroluminescent layer sequence. Moreover a fabric material can also be laminated directly onto the electroluminescent layer sequence or laminated via the TPU or TPE layer.

It is possible to configure the TPU or TPE film graphically. This optional graphical configuration is preferably implemented by means of screen printing and can have opaque as well as translucent or glazing, graphically configured elements. In this way an electroluminescent system arranged underneath can in addition be masked or the electroluminescence emission can be filtered or converted as regards the emission colour. The preferred screen printing technology implementation of the graphical configuration provides, when using corresponding elastic screen printing inks, based for example on polyurethane or two-component screen printing inks based on polyurethane, the necessary flexibility and foldability of the resulting electroluminescent arrangement.

The optional graphical configuration of the TPU or TPE film can in principle be present on either side of the film. It is preferred however if the graphical configuration is arranged on the side of the TPU film on which also the electroluminescent layer sequence is arranged. The graphical configuration is preferably implemented by means of screen printing.

In a further preferred embodiment of the present invention a carrier system in the form of a special coated paper or a temperature-stabilised polyester film with an anti-adhesive coating (so-called release coating) is used for the individual electroluminescent layers. After the preparation of the various electroluminescent layer sequences, also described in more detail hereinbelow, with the necessary interpolated drying processes, the coated paper or the temperature-stabilised polyester film serves as a transfer medium for transfelTing the electroluminescent layer sequence to the surface substrate or to the TPU film.

In a further preferred embodiment of the present invention a carrier system in the form of a special coated paper or a temperature-stabilised polyester film with an anti-adhesive coating (so-called release coating) is used, on which the TPU or TPE film is arranged, and in this way the dimensional stability is improved, especially at elevated temperature. In this way the electroluminescent layer sequence can then be arranged directly on the TPU or TPE film.

The joining of the electroluminescent system to the textile carrier material via the adhesive layer based on TPU can be achieved under the action of pressure and/or temperature on the individual constituent parts of the arrangement according to the invention.

Moreover, it is possible in the scope of the present invention for the electroluminescent arrangement according to the invention to have a textile carrier material on both sides of the electroluminescent element. In this case the electroluminescent element can be joined on each side via a corresponding TPU film, described above, to the respective textile carrier materials.

In the first, preferred structure of the electroluminescent arrangement according to the invention a textile carrier material is used as surface substrate. This textile carrier material can be employed for example in a vehicle. The lower side, which is aligned in the direction of the desired electroluminescence emission, i.e. for example in the direction of the interior of a vehicle, is implemented for example in such a way that an adhesive bonding with a thermoplastic film or layer or with a heat-sealable layer of adhesive agent or a heat-sealable fleece is possible.

As already mentioned, on this surface of the textile carrier material an optionally graphically configured TPU film as carrier for the electroluminescent system can be joined to the surface of the textile carrier material as a laminate.

The TPU film can, as likewise already mentioned, optionally also or only on the underneath also be provided with a graphical configuration, and is used on one side of the carrier for the electroluminescent layers.

Furthermore, instead of the TPU film another bonding layer can also be used, provided that the preferably achievable flexibility and workability of the resulting arrangement is obtained.

Finally, the electroluminescent element of the electroluminescent arrangement according to the invention can also be provided on the other side, i.e. on the rear electrode, with a carrier material. In this connection this may also be a flexible textile carrier material, which is optionally also joined via a TPU adhesive layer or another adhesive layer to the electroluminescent element.

The EL arrangement according to the invention on a textile material is characterised inter alia by the fact that an arrangement with a surface area of 20 cm×20 cm, preferably 16 cm×16 cm, particularly preferably 12 cm×12 cm, with a thickness of in each case 450 to 750 μm, can be folded by ca. 180° at least twice, preferably three times, particularly preferably four times along the centre of the surface, the resulting folded object having a height of at most 4 cm, preferably at most 3 cm, particularly preferably at most 2 cm, without the luminosity of the EL arrangement being adversely affected. The folding should be carried out in such a way that a square and a rectangle are alternately formed with each folding operation; the contactings of the EL arrangements should be excluded from the folding. Also, after the unfolding of the EL arrangement the latter is luminous to the same extent as before. For EL arrangements of other sizes the details given above regarding the folding and folded object apply in proportion. Thus, EL arrangements of larger area and/or smaller thickness can of course be folded more times than those of smaller area and/or larger thickness.

Arrangement in a Vehicle

The luminous fields generated by the electroluminescent arrangement according to the invention can in a preferred embodiment have a protective layer on the side facing towards the interior of the vehicle. These can likewise be designed so as to be foldable, and serve as a mechanical and electrical protection for the electroluminescent arrangement.

If the electroluminescent arrangement according to the invention is used in a vehicle, then the voltage supply for the luminous fields is preferably provided by the vehicle battery. The vehicle battery, which normally operates with 12V direct current, is connected downstream to a DC/AC transformer, which converts the direct current from the battery to alternating currents. Converters, which are connected to the DC/AC transformers, are associated with the luminous fields. The converters operate for example in each case with a voltage of 120V and a frequency of 400 Hz. The converters are preferably equipped with dimmers, so that the brightness of the luminous fields can easily be regulated.

By means of an input device, which is preferably arranged within reach of the driver, the respective luminous fields can be switched on or off via corresponding buttons. The buttons can be film-type buttons, but also conventional push buttons.

The luminous fields are illuminated over their whole surface area when a corresponding current is supplied. On account of the laminar illumination a pleasant lighting effect is produced in the vehicle interior. The luminous fields can have the same shade, but also different shades. The luminous fields are provided for example in the region of the vehicle roof Instead of the three individual luminous fields, alternatively only a single luminous field could be provided, which then extends over the area of the roof of the vehicle. In this case the whole passenger interior is uniformly lit. However, for example only the front seats or also only the rear seats of the vehicle can be illuminated. In this case the corresponding luminous fields are provided only in the front or rear part respectively of the roof of the vehicle interior.

Passive or active converters can be used as converters.

Production of the Electroluminescent Arrangement According to the Invention

The present invention also relates to processes for producing the electroluminescent arrangement according to the invention.

In principle it is possible to produce the electroluminescent arrangement according to the invention in two different ways:

In a first embodiment of the present invention the electroluminescent arrangement according to the invention is fabricated starting from the textile carrier material. A TPU film is laminated onto this textile carrier material. The electroluminescent layer sequences, comprising at least the cover electrode, the electroluminescent layer, optionally the insulating layer (dielectric layer) as well as the rear electrode, can then be applied to the TPU film by printing techniques, in particular by screen printing. The application of the individual functional layers of the electroluminescent arrangement according to the invention is generally effected in the sequence specified above, wherein the electroluminescence emission that is emitted by the electroluminescent layer is transmitted through the cover electrode and the textile carrier material by the electroluminescent layer.

The second embodiment of the present invention differs as regards the production of the electroluminescent arrangement according to the invention in terms of the procedure, in that the electroluminescent system is first of all printed onto the TPU film and is then joined as a semi-finished product to the textile carrier material by laminating techniques. In this second embodiment the cover electrode and the graphical configuration should be formed as a bonding agent for the surface substrate.

The present invention also provides the electroluminescent arrangements obtainable by these processes.

Use

The present invention moreover relates to the use of the electroluminescent arrangement according to the invention as well as the electroluminescent arrangement obtainable by the process according to the invention, for lighting purposes.

In particular the present invention relates to the use of the electroluminescent arrangement according to the invention as well as the electroluminescent arrangement obtainable by the process according to the invention, for lighting the interiors of vehicles, for seating elements such as for example chairs or seats, and for articles of clothing such as for example sportswear.

With the lighting device according to the invention it is also advantageous to be able to alter the lighting depending on the frequency and voltage. Thus, for example, the emitted light colour can be adjusted by altering the frequency applied to the electrodes of the layer arrangement, and the brightness can be adjusted by altering the voltage. If a suitable designed control device is used, then the interior lighting of the vehicle can thereby be adapted to specific situations. If for example certain coloured pigments are admixed with the electroluminescing layer, then—as already explained—different lighting colours can be preset.

By means of the invention completely new potential uses are furthermore opened up for the textile materials provided with a luminous strip. These include in particular the uniform marking out and identification of floor regions, for example in aircraft or to indicate emergency escape routes, wall sections and handrails in premises and on sites, as well as all other types of self-luminescent markings. The small thickness of the electroluminescent arrangement according to the invention enables the latter to be easily applied for example to the outside of a textile cladding/lining element. Also, the luminous strip can be designed in the form of a profiled element that fits in a recess or groove of the textile cladding/lining element and is held therein in a positive interlocking and/or frictional manner. In this connection either a relatively rigid luminous strip profile can be held in a positive interlocking manner in a correspondingly shaped groove after insertion, or a flexible (rubber-like) profile can be held in a largely frictional manner after being pressed into a groove of the cladding/lining element.

### DESCRIPTION OF THE FIGURES

The present invention is described in more detail with the aid of two figures, though the present invention is however not restricted to the embodiments shown in these figures.

### LIST OF REFERENCE NUMERALS

1. Flexible luminous element
2. Surface substrate of textile material or leather or imitation leather
3. TPU or TPE film (e.g. films identified as “Dureflex® A 4700 Optical Aliphatic Polyether Polyurethane Grade” from the Deerfield Urethane company or highly elastic polyurethane films identified as Platilon® and Walopur® from the epurexfilms company)
4. Graphical configuration
5. Upper transparent electrically conducting cover electrode
6. Electroluminescent layer (zinc sulfide electroluminophore in a polymeric matrix, for example in a two-component PU screen printing layer)
7. Insulating dielectric (e.g. two-component PU screen printing ink with perovskite/ferroelectric particles dispersed therein, in particular particles with nanostructures and optionally electrically conducting nanoparticles, in particular CNTs or MWCNTs and the like)
8. Rear electrode (depending on the use, in opaque implementation in the form of a carbon print layer with grid-like silver paste printing as a flat busbar or largely transparent or translucent electrode similar in implementation to the upper transparent electrically conducting electrode
9. Bonding agent layer (e.g. TPU/TPE film or non-woven hot-melt fleece or adhesive layer); optional
10. Textile material or leather or imitation leather in the form of a fabric or fleece (non-woven); optional
11. Electroluminescence emission upwardly
12. Electroluminescence voltage supply (normally 100 to 200V alternating voltage at 50 Hz to several 1,000 Hz, normally in the range 200 Hz to 2,000 Hz)
13. Electroluminescent capacitor
14. Electroluminescent binder polymer
15. Electroluminescent pigment
16. Dielectric binder polymer
17. Additive for the dielectric (e.g. BaTiO₃ pigments in μm and sub-μm and nm range and various nanoscale conducting particles, such as CNTs)
18. Electroluminescence emission downwards

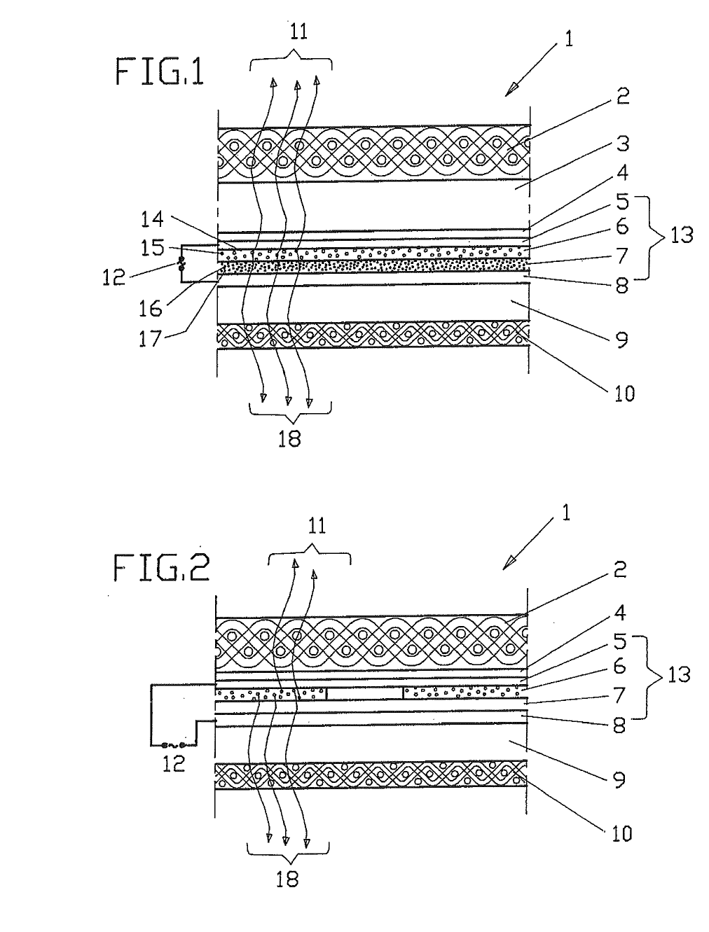

In FIG. 1 a diagrammatic section through an exemplary flexible luminous element 1 is shown in a first embodiment.

In this connection a surface substrate 2 of textile woven or fleece-like material or leather or imitation leather is used as uppermost layer. The surface substrate 2 is a flat element, which has a light transmissibility in the visible wavelength range of at least 40%, in particular however more than 50%, and is optionally provided with small holes or with patterns of reduced thickness, and has a corresponding surface structure or etching or embossing, and is optionally artistically coloured, wherein in the region of electroluminescent fields a bright or translucent or glazing-type colouration is preferably used. The lower side of the surface substrate 2 is implemented in such a way that an adhesive bonding with a thermoplastic film or layer or with a heat-sealable adhesive agent layer or a heat-sealable fleece is possible.

The TPU film 3 can on the underneath also be provided with an optional graphical configuration 4 and is used on one of the sides as a carrier for the electroluminescent layers 13 and is joined together with these layers 4, 13 to the surface substrate 2 by means of lamination. As TPU film 3 there may for example be used films identified as Dureflex®, Platilon® and Walopur® from the Epurex Film company, a Bayer MaterialScience company. Such films can be used with or without a carrier film and have film thicknesses of 0.01 to 2 mm, in particular 0.02 to 0 5 mm and most especially 0.15 to 0.40 mm.

The optional graphical configuration 4 can in principle also be arranged on the upper side of the TPU film, though is preferably arranged on the lower side since the electroluminescent layer sequence 13 too is arranged on the lower side. The graphical configuration 4 is preferably implemented by means of screen printing and can have opaque as well as translucent or glazing-type graphically configured elements, and in this way an electroluminescent system 13 arranged thereunder can in addition be masked or the electroluminescence emission 11 can be filtered or converted as regards the emission colour. The preferred screen printing technique implementation of the graphical configuration 4 provides the necessary flexibility and foldability if corresponding elastic screen printing inks based for example on PU or two-component polyurethane-based screen printing inks are used.

The electroluminescent layer sequence 13 is mainly produced according to the prior art in the sequence comprising the printing technology production of the upper electrode 5, the electroluminescent layer 6, the at least one insulating dielectric layer 7 and the rear electrode 8 with suitable elastic screen printing inks.

The at least in part upper largely transparent electrode 5 must likewise have a good flexibility and foldability and is preferably produced by means of screen printing corresponding to the graphically required configuration. The electrode 5 can be implemented according to the prior art with ITO indium/tin oxide or ATO antimony/tin oxide screen printing pastes, and/or intrinsically conducting screen printing pastes can be used based on polymer systems such as the Orgacon® system from Agfa, the Baytron® poly-3,4-ethylenedioxythiophene system from H.C. Starck GmbH, the system from Ormecon termed organic metal PEDT-conductive polymer polyethylene-dioxythiophene system, electrically conducting coating systems or printing ink systems from Panipol OY and optionally with highly flexible binders, for example based on PU (polyurethanes), PMMA (polymethylmethacrylate), PVA (polyvinylalcohol) or modified polyaniline.

Preferably the Baytron® poly-3,4-ethylenedioxythiophene system from H.C. Starck GmbH is used as material of the at least partially transparent electrode 5 of the electroluminescent element.

Examples of electrically conducting polymer films are polyanilines, polythiophenes, polyacetylenes, polypyrroles, listed in Handbook of Conducting Polymers, 1986 with and without metal oxide fillings.

The electroluminescent layer 6 is likewise preferably produced by screen printing techniques, attention being paid to a good flexibility and foldability. In this connection a polymeric elastic binder matrix 14 is used, preferably based on polyurethane and particularly preferably in a two-component embodiment. Preferably zinc sulfide electroluminophore pigments 15 are dispersed in this binder polymer 14. Such electroluminescent pigments 15 are preferably used microencapsulated with thin and transparent metal oxide or nitride layers, or are also used unencapsulated. In addition electroluminescent pigments 15 with different emission wavelengths can be used, wherein the different electroluminescent pigments 15 can be used mixed or in differently graphically configured electroluminescence fields or elements. Furthermore colour-converting admixtures such as colour converting pigments or colorants can be used in the polymer matrix 14 and/or the electroluminescent pigments 15 can be provided with such colour-converting microencapsulations. In principle also the colour-converting admixtures in the printed layer 4 can be contained over the whole area or can be contained graphically configured.

The insulating dielectric layer 7 is then arranged on the electroluminescent layer 6. This layer 7 too must also be designed so as to be flexible and foldable. Normally in this case also a polyurethane-based and most particularly preferably a two-component PU screen printing ink is preferably used, wherein in order to increase the relative dielectric constant barium titanate BaTiO₃ pigments in the μm range, in the 100 to 400 nm range and in the 5 to 100 nm range can be added, and in this way a relative dielectric constant of 30 to 200 can be achieved. Since such BaTiO₃ admixtures produce an opaquely whitish layer, this layer can also be used for the reflection of the electroluminescence emission 11. If in addition to the upwards electroluminescence emission 11 a downwards electroluminescence emission 18 is also necessary, then no BaTiO₃ should be added. The dielectric layer 7 can also be repeated two or more times, since specifically in the case of screen printing the incorporation of small air bubbles (microbubbles) cannot be avoided, and this problem can be solved by a double screen printing.

The rear electrode 8 is then printed onto the dielectric layer 7, and here too attention must be paid to a high elasticity and foldability. If only an upwards electroluminescence emission 11 is necessary, the rear electrode 8 can be printed for example with a carbon screen printing paste of a few 100Ω/square, and following this a grid-like silver paste printed image in the manner of a busbar system can then be arranged. Since normal silver pastes have a sheet resistance in the region of a few milliohms/square and besides permit very expandable printed images, grid-like images with a few 1 to 5 mm wide silver paste tracks are sufficient. These silver paste elements are in principle also used as connection reinforcing elements for the electrical contacting 12. In this connection a partial region of the front electrode 5 is also printed in the manner of a busbar in a silver paste impression and the electrical connection 12 is formed.

An insulating layer 9 is arranged adjacent to the rear electrode 8 with the busbar system. In the simplest embodiment this can be implemented by means of screen printing. In a further embodiment a TPU film 9 can be applied by lamination techniques, and in yet a further variant of implementation a textile material 10 or leather or imitation leather PU-coated microfibre fabric and the like can be laminated onto this layer 9.

In FIG. 2 a diagrammatic section through an exemplary flexible luminous element 1 is illustrated in a second embodiment.

Compared to the first embodiment, in this layer sequence the major difference is that the electroluminescent system 13 is printed on the TPU film 9 and is joined by laminating techniques as a semi-finished product to the surface substrate 2.

In principle this production variant is also possible in the first embodiment, if the TPU film 9 is provided in this first embodiment.

In the arrangement of the electroluminescent system 13 on the film 9 it can clearly be seen that first of all the rear electrode 8, then the at least one dielectric layer 7, then the electroluminescent layer 6, then the front electrode 5 and finally optionally the graphical configuration 4 are arranged.

In this second embodiment the front electrode 5 and the graphical configuration 4 must be formed as an adhesive agent for the surface substrate.

In this second embodiment a textile material 10 or leather or imitation leather PU-coated microfibre fabric and the like can be laminated onto the rear side.

Also, this second embodiment can be configured so that an electroluminescence emission 11, 18 can occur on both sides.

1-9. (canceled)

10. An electroluminescent arrangement comprising at least one flexible electroluminescent element and at least one flexible textile carrier material.

11. The electroluminescent arrangement of claim 10, wherein said at least one textile carrier material is fabricated from the group consisting of plant fibres, fibres of animal origin, mineral fibres of geological origin, chemical fibres, fibres of synthetic polymers, inorganic chemical fibres, and imitation leather.

12. The electroluminescent arrangement of claim 10, wherein said at least one textile carrier material is a textile carrier material that can be used in vehicles.

13. The electroluminescent arrangement of claim 12, wherein said at least one textile carrier material is a textile carrier material that can be used for the roof of a vehicle.

14. The electroluminescent arrangement of claim 10, wherein said at least one electroluminescent element comprises the following layer structure:
a) a transparent or non-transparent rear electrode as component BE;
b) a first insulating layer as component BD;
c) a layer containing at least one luminous substance that can be excited by an electrical field as component BC;
d) optionally a further insulating layer as component BB; and
e) at least one partially transparent cover electrode as component BA.

15. The electroluminescent arrangement of claim 10, wherein said at least one textile carrier material is adhesively bonded to said electroluminescent arrangement via an adhesive layer formed from TPU.

16. A process for producing the electroluminescent arrangement of claim 14, comprising
laminating a TPU film onto a textile carrier material, and
applying electroluminescent layer sequences comprising at least a cover electrode (component BA), optionally a dielectric layer (component BB), an electroluminescent layer (component BC), an insulating layer (component BD), and a rear electrode (component BE) to said TPU film via a printing technique,
wherein said electroluminescent arrangement is produced starting from said textile carrier material.

17. The proces of claim 16, wherein said printing technique is screen printing.

18. The process of claim 16, wherein the electroluminescent element is first of all printed on the TPU-based adhesive layer and is then joined as a semi-finished article to the textile carrier material by laminating techniques.

19. A vehicle interior light, a seating unit, or an article of clothing comprising an electroluminescent arrangement prepared by the process of claim 16.

20. The seating unit of claim 19, wherein said seating unit is a chair or seat.

21. The article of clothing of claim 19, wherein said article of clothing is sportswear.
